(19) United States
(12) Patent Application Publication
(10) Pub. No.: US 2005/0155694 A1
(43) Pub. Date: Jul. 21, 2005

(54) Wear-resistant mechanical component and method of producing the same

(75) Inventors: Dong Sub Sim, Ansan-si (KR); Kyung Woon Kim, Incheon (KR); Keun Chul Song, Seoul (KR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: DAEWOO HEAVY INDUSTRIES & MACHINERY LTD., Incheon (KR)

(21) Appl. No.: 11/019,182

(22) Filed: Dec. 23, 2004

(30) Foreign Application Priority Data
Dec. 24, 2003 (KR) 2003-96472
Aug. 5, 2004 (KR) 2004-61564

(51) Int. Cl. B22F 3/00; B32B 1/06

(52) U.S. Cl. 156/81; 428/545; 428/617; 428/627; 428/621

(57) ABSTRACT

A wear-resist mechanical component used in a frictional contact area requiring wear-resistance and a method of producing the same is provided. The method comprises the steps of: depositing hard particles of one or more substances selected from the group consisting of carbides, nitrides and borides on an iron-based metal body to a predetermined thickness; depositing binder powders atop of the hard particle layer to a predetermined thickness; and heating the hard particles, the binder powders and the iron-based metal body, so that the iron-base metal body and the hard particles are bonded together. This can obtain a wear-resistant mechanical component having high hardness and excellent wear resistance without having to go through the step of mixing hard particles with binder to form the mixture. The super-hard alloy can be bonded to the base metal body regardless of the shape of the base metal body.

### BACKGROUND OF THE INVENTION

1. Field of the Invention

The present invention relates to a wear-resistant mechanical component and a method of producing the same. More specifically, the present invention is directed to a wear-resistant mechanical component with a layer of super-hard alloy formed on a base metal body, so that the wear-resistant mechanical component can be used at a frictional contact area where wear-resistance is required, and a method of producing the same.

2. Background of the Invention

Super-hard alloy is formed from hard particles such as carbides including tungsten carbide and chromium carbide, nitrides or borides, and a binder such as single metal including nickel and cobalt or alloy including nickel-based or cobalt-based alloy. By virtue of its excellent wear resistance, the super-hard alloy has been widely used in the field of tools and mechanical parts requiring high wear resistance.

In order for the super-hard alloy to be used as a mechanical component, it is generally bonded to a base metal body such as iron-based alloy. For example, there has been proposed a method of bonding super-alloy comprising steps: mixing hard particles and a binder to form a mixture of the hard particles and the binder, shaping the mixture into a preform of desired shape, heating and sintering the preform to produce a sintered body, and then bonding the sintered body to a base metal body with or without filler metal.

There has been also proposed a method of bonding super-hard alloy comprising the steps of: mixing hard particles and resin to form a mixture of the hard particles and resin, shaping the mixture into a desired mixture preform, placing the mixture preform on a base metal body, and then heating the preform so that the preform is bonded to the base metal body while the resin is removed.

However, the above-mentioned methods have a disadvantage in that they should necessarily go through the mixing, shaping and sintering steps in order to produce mechanical components, which leads to prolonged manufacturing time, a great deal of labor power and increased manufacturing costs.

In addition, it is required in the prior art method that a sintered body be bonded to a base metal body. The sintered body is difficult to bond particularly when the shape of a base metal body is complicated, meaning that the prior art methods have a limited use.

Taking this into consideration, there has been proposed a method of thermally bonding a preform to a base metal body without sintering step. In that event, however, there is a problem in that the preform cracks and splits while being thermally shrunk in the bonding process.

Another example of bonding methods is thermal spraying. Such a thermal spraying method comprises the steps of: mixing hard particles and powders of binder in a predetermined ratio, heating the mixture to a temperature above the melting point thereof by using high-pressure gas, spraying the heated mixture against a base metal body so that a heterogeneous spray coating containing a multiplicity of pores is formed on the base metal body, and melting again the spray coating formed on the base metal body to remove the pores, thereby bonding super-hard alloy to the base metal body.

Such a bonding method has a disadvantage in that the mixed powders are scattered or disappear in the process of spraying the heated spray coating against the base metal body and the recovery rate thereof is very low. In addition, because it is necessary to heat the mixture after hard particles and binder powders are mixed, to melt the mixture, to spray the molten mixture against the base metal body, and then to melt again the spray coating, the entire process is very complicated. This leads to prolonged production time, enlarged labor power and increased manufacturing costs.

### DISCLOSURE OF THE INVENTION

Accordingly, the present invention has been conceived to solve the above-mentioned drawbacks inherent in the prior art, and an object of the present invention is to provide a wear-resistant mechanical component having excellent bond strength and a method of producing the same through a simpler process.

Another object of the present invention is to provide a wear-resistant mechanical component having high hardness and excellent wear resistance and a method of producing the same using simpler bonding step.

Still another object of the present invention is to provide a wear-resistant mechanical component having excellent bond strength regardless of the shape of a base metal body and a method of producing the same.

In order to achieve the above-mentioned objects, according to the present invention, there is provided a method of producing a wear-resistant mechanical component comprising the steps of: depositing hard particles of one or more substances selected from the group consisting of carbides, nitrides and borides on an iron-based metal body to a predetermined thickness; depositing powders of binder atop of the hard particle layer to a predetermined thickness; and heating the hard particles, binder powders, and the iron-based metal body, so that the iron-based metal body and the hard particle are bonded together.

The method may further comprise step of compressing the hard particle layer after the step of depositing the hard particles on the iron-based metal body.

### BRIEF DESCRIPTION OF THE DRAWINGS

The above and other objects, features and advantages of the present invention will be more apparent from the following detailed description taken in conjunction with the accompanying drawings, in which:

FIG. 1 schematically shows a wear-resistant mechanical component according to the present invention;

FIG. 2 is a flowchart illustrating a method of producing a wear-resistant mechanical component according to the present invention;

FIGS. 3 to 5 are cross-sectional views schematically showing the steps of a method of producing a wear-resistant mechanical component according to the present invention;

FIG. 6 is a microscopic photograph showing the structure of a bonding interface between the super-hard alloy and iron-based metal body of a wear-resistant mechanical component produced according to the inventive method;

FIG. 7 is a flowchart illustrating a method of producing a mechanical component according to the present invention; and

FIGS. 8 to 11 are cross-sectional views schematically showing the steps of a method of producing a wear-resistant mechanical component according to another embodiment of the present invention.

### DETAILED DESCRIPTION OF PREFERRED EMBODIMENTS

Preferred embodiments of the present invention will now be described with reference to the accompanying drawings.

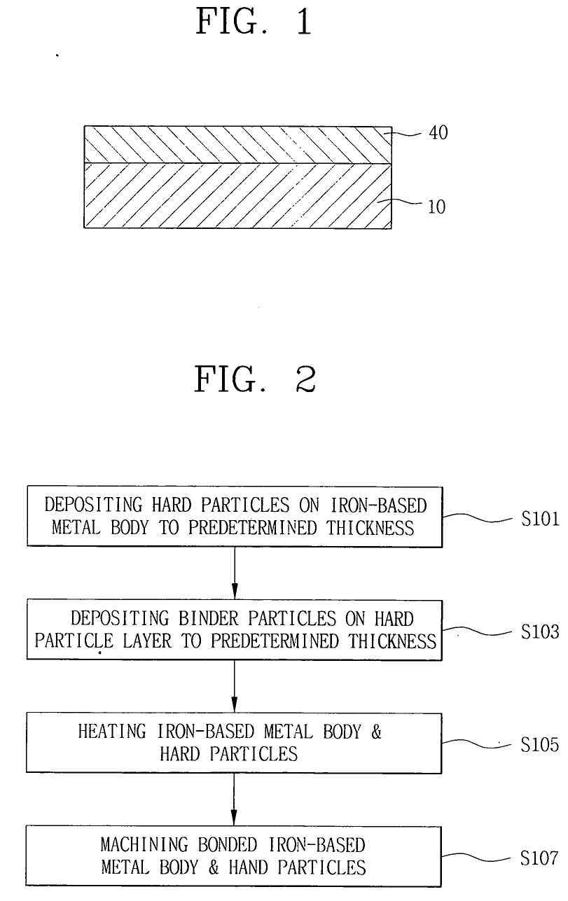

Referring first to FIG. 1, the inventive wear-resistant mechanical component comprises an iron-based metal body 10 and a layer of super-hard alloy 40 bonded to the iron-based metal body 10. The super-hard alloy layer 40 is produced by heating powers formed by mixing hard particles, composed of one or more substances selected from carbides, nitrides and borides, with a binder.

An example of the binder contains boron (B) in the amount of 1 to 5 wt %, silicon (Si) in the amount of 1 to 5 wt %, chromium (Cr) in the amount of 5 to 10 wt %, iron (Fe) in the amount of 1 to 5 wt %, and balance nickel, on the basis of the weight of the entire composition of the binder. The binder is added in the amount of 1 to 5 times of the hard particles by weight.

Another example of the binder contains carbon (C) in the amount of 0.01 to 1 wt %, boron (B) in the amount of 0.5 to 10 wt %, silicon (Si) in the amount of 3 to 12 wt %, chromium (Cr) in the amount of 2 to 20 wt %, iron (Fe) in the amount of 0.1 to 4 wt %, on the basis of the weight of the entire composition of the binder, and balance nickel. This binder is excellent in mixing performance with the above-mentioned hard particles, and is added in the amount of 0.2 to 4 times greater than the hard particles by weight.

Meanwhile, although carbon (C) and boron (B) may be included as the components of the binder, boron carbide (B₄C) can be added instead of those components. The boron carbide (B₄C) is added in the amount of 0.6 to 11 wt % on the basis of the weight of the entire composition of the binder, if required.

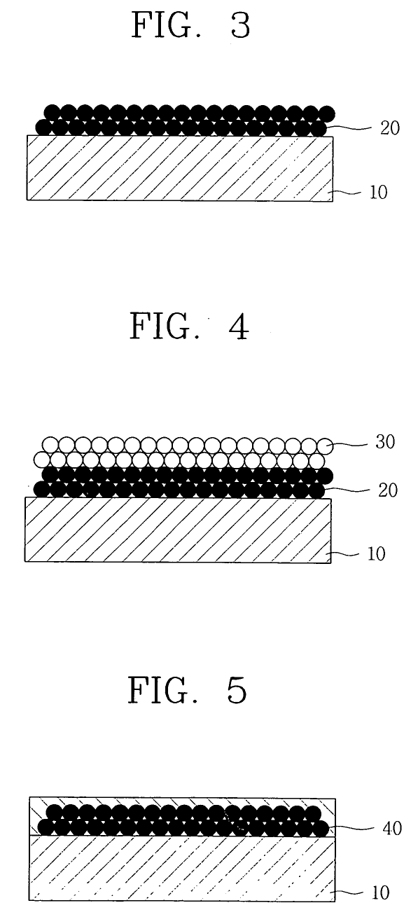

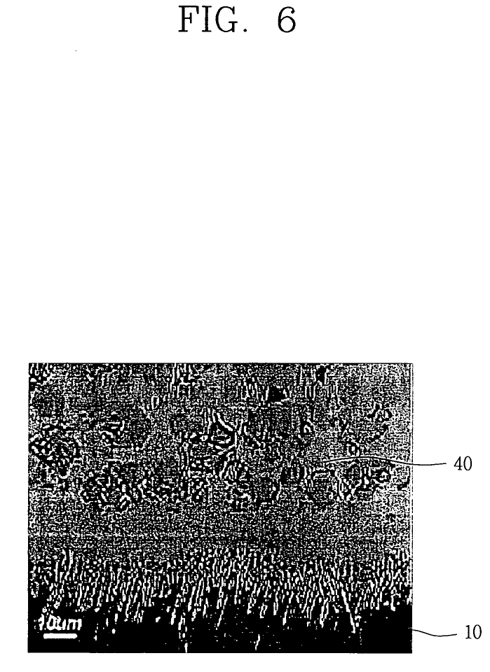

Now, the method of producing a wear-resistant mechanical component is described in detail with reference to FIGS. 2 to 6.

At first, the inventive method comprises the steps of providing hard particles as a raw material of super-hard alloy, and depositing the hard particles on an iron-based metal body 10 to a predetermined thickness, thereby forming a hard particle layer 20 (S101). Carbides, nitrides or borides are used as raw material powders and tungsten carbide (WC) may be included.

If the deposition of the hard particles is completed, binder powders are provided and then deposited on the hard particle layer 20, thereby forming a binder layer 30 (S103). The binder powders may contain boron (B) or boron-containing compound, silicon (Si), chromium (Cr), iron (Fe), and nickel (Ni). It is possible to use either alloyed powders or mixed powders of the respective binder element, as the binder powders.

As can be seen from the experimental result in Table 1 noted below, it is most preferred that the binder contains boron (B) in the amount of 1 to 5 wt %, silicon (Si) in the amount of 1 to 5 wt %, chromium (Cr) in the amount of 5 to 10 wt %, iron (Fe) in the amount of 1 to 5 wt %, on the basis of the weight of the entire composition of the binder, and balance nickel.

This is because, if the amount of boron, silicon, iron, chromium, and nickel are out of the ranges indicated above, the melting point of the binder is increased, as a result of which the binder neither reacts with the hard particles in the process of heat treatment described later nor bonds the hard particles to the iron-based metal body.

TABLE 1
Binder Characteristics of Varying Composition

| | | | | | | Hard | | Reaction |
|---|---|---|---|---|---|---|---|---|
| | | | | | | particle | | with |
| | Binder | | | | | (vs. | | iron-based |
| Experiment | (wt %) | | | | | binder) | Binder | metal |
| No. | B | Si | Cr | Fe | Ni | WC | melt | body |
| 1 | 0.9 | 0.9 | 4.9 | 0.9 | bal. | 1 times | Partially | Non |
| | | | | | | | melt | |
| 2 | 0.9 | 1.1 | 5.0 | 1.0 | bal. | 1 times | Non | Non |
| 3 | 1.0 | 0.9 | 5.0 | 1.0 | bal. | 1 times | Partially | Non |
| | | | | | | | melt | |
| 4 | 1.1 | 1.2 | 4.9 | 1.0 | bal. | 1 times | Non | Non |
| 5 | 1.0 | 1.0 | 5.0 | 1.0 | bal. | 1 times | Melt | Reacted |
| 6 | 2.7 | 3.4 | 7.4 | 2.8 | bal. | 1 times | Melt | Reacted |
| 7 | 3.3 | 2.8 | 8.3 | 4.5 | bal. | 1 times | Melt | Reacted |
| 8 | 5.0 | 5.0 | 10.0 | 5.0 | bal. | 1 times | Melt | Reacted |
| 9 | 5.1 | 5.1 | 10.1 | 5.1 | bal. | 1 times | Partially | Non |
| | | | | | | | melt | |
| 10 | 5.3 | 4.6 | 7.8 | 2.3 | bal. | 1 times | Non | Non |
| 11 | 3.3 | 5.3 | 6.2 | 3.2 | bal. | 1 times | Non | Non |
| 12 | 4.5 | 3.2 | 10.4 | 4.0 | bal. | 1 times | Non | Non |
| 13 | 4.5 | 3.2 | 5.8 | 5.4 | bal. | 1 times | Non | Non |
| 14 | 5.1 | 5.1 | 10.1 | 5.1 | bal. | 1 times | Partially | Non |
| | | | | | | | melt | |

In addition, according to the experimental results of Table 2 noted below, it is preferred that the binder should be added in the amount of 1 to 5 times of the hard particles by weight. This is because, if the weight of the binder is less than 1 times of the hard particles by weight, the super-hard alloy layer may crack and split in the process of heat treatment, and if the weight of the binder is greater than 5 times of the hard particles by weight, the hardness of the super-hard alloy may be decreased after the heat treatment.

TABLE 2
Effect of Binder-to-Hard Particle Ratio

| Ex- | | | | | | Weight ratio | Hardness | |
|---|---|---|---|---|---|---|---|---|
| peri- | | | | | | of binder over | of super- | Crack of |
| ment | Binder (wt %) | | | | | hard particles | hard alloy | super-hard |
| No. | B | Si | Cr | Fe | Ni | (WC) | layer | alloy layer |
| 1 | 2.7 | 3.4 | 7.4 | 2.8 | bal. | 0.9 times | HRA 85 | Exist |
| 2 | 2.7 | 3.4 | 7.4 | 2.8 | bal. | 1 times | HRA 83 | Non |
| 3 | 2.7 | 3.4 | 7.4 | 2.8 | bal. | 3 times | HRA 83 | Non |
| 4 | 2.7 | 3.4 | 7.4 | 2.8 | bal. | 5 times | HRA 80 | Non |
| 5 | 2.7 | 3.4 | 7.4 | 2.8 | bal. | 6 times | HRA 74 | Non |

Binder powders of another example may contain carbon (C), boron (B), silicon (Si), chromium (Cr), iron (Fe) and nickel (Ni). In addition, it is possible to use either alloyed powders or mixed element powders as the binder powders.

According to the experimental results, it has been founded that it is most preferable to use a binder containing carbon (C) in the amount of 0.01 to 1 wt %, boron (B) in the amount of 0.5 to 10 wt %, silicon (Si) in the amount of 3 to 12 wt %, chromium (Cr) in the amount of 2 to 20 wt %, iron (Fe) in the amount of 0.1 to 4 wt %, on the basis of the weight of the entire composition of the binder, and balance nickel.

This is because, if boron and silicon, which tend to reduce the melting point of the binder, are added in the amounts of less than 0.5 wt % and 3.0 wt %, respectively, the effect of reducing the melting point of nickel alloy becomes minute, and if boron and silicon are added in the amounts of more than 10 wt % and 12 wt %, respectively, an Ni—Si—B or Si—B series alloy may be formed, thereby increasing brittleness. Accordingly, it is appropriate that boron and silicon are added in the amount of 0.5 to 10 wt % and 3 to 12 wt %, respectively.

In addition, if chromium, which improves anti-corrosion property and exhibits an effect of increasing strength at high temperature, is added in the amount of less than 2 wt %, the anti-corrosion property becomes minute and if the chromium is added in the amount of more than 20 wt %, carbide is formed, thereby decreasing the anti-corrosion property of nickel alloy. Therefore, it is appropriate that chromium is added in the amount of 2 to 20 wt % on the basis of the weight of the binder.

Unless carbon and iron, which serve as solid solution hardening elements, are added to the binder, the hardness of nickel alloy is greatly reduced. If carbon is added in the amount of more than 1.0 wt %, an excessive amount of carbon, which is not solved in the phase of solid solution, is produced and deteriorates the structural evenness. And, if iron is added in the amount of more than 4 wt %, a Ni—Fe series alloy is formed, thereby decreasing the hardness of the nickel alloy. Therefore, it is appropriate that carbon and iron are added in the amount of 0.01 to 1 wt % and 0.1 to 4 wt %, respectively, on the basis of the weight of the binder.

According to the experimental results, it has been founded that it is most preferable to use a binder having the weight of 0.2 to 4 times greater than the hard particles. This is because, if the weight of the binder is less than 0.2 times of the hard particles, the binder powders are insufficiently penetrate into voids between hard particles, and thus the super-hard alloy layer may crack and split after heat treatment. If the weight of the binder is more than 4 times of that of the hard particles, the binder powders remaining after penetrating into the voids between the hard particles flow up and down of the bond surface, thereby forming unevenness on the surface of the bonded super-hard alloy layer.

Although the above-mentioned another example was described to use carbon (C) and boron (B) as the components of the binder, it is possible to add boron carbide (B₄C) instead of those components. Boron carbide (B₄C) is solved into a nickel-based alloy in the form of boron B and carbon C at a temperature above 900° C., thereby serving as a substituent for carbon and boron. It is preferable to add the boron carbide (B₄C) in the amount of 0.6 to 11 wt % on the basis of the weight of the entire composition of the binder.

Referring again to FIGS. 2, 4 and 5, after the deposition of the hard particles and binder has been completed, the hard particle layer 20 and binder layer 30 deposited in this order are heated to bond the iron-based metal body 10 and the hard particles together (S105). Specifically, if the deposited hard particle layer 20 and the binder layer 30 are heat-treated, the binder layer 30 is molten by the heat applied, the molten binder penetrates into and passes through the voids formed in the hard particle layer 20, thereby fixing the hard particles while coming into contact with the iron-based metal body 10, so that the hard particles are bonded to the iron-based metal body 10 through diffusion reaction. Through this reaction, a super-hard layer 40 is formed on the iron-based metal body 10.

The step of heat treatment is performed for 5 minutes to 10 hours at a temperature between about 980 to 1,200° C. in an atmosphere of nitrogen gas, hydrogen gas and argon gas, which are inert or reducing agents, with the use of an oxygen torch, or in a vacuum atmosphere.

If the heat treatment is completed, the iron-based metal body and super-hard alloy bonded together is gradually cooled under the normal temperature, and the cooled mechanical component is subjected to machining treatment (S107). The machining treatment is carried out to cut and grind the inner and outer surfaces of the mechanical component in the shape suitable for use, thereby enhancing the accuracy of the mechanical component.

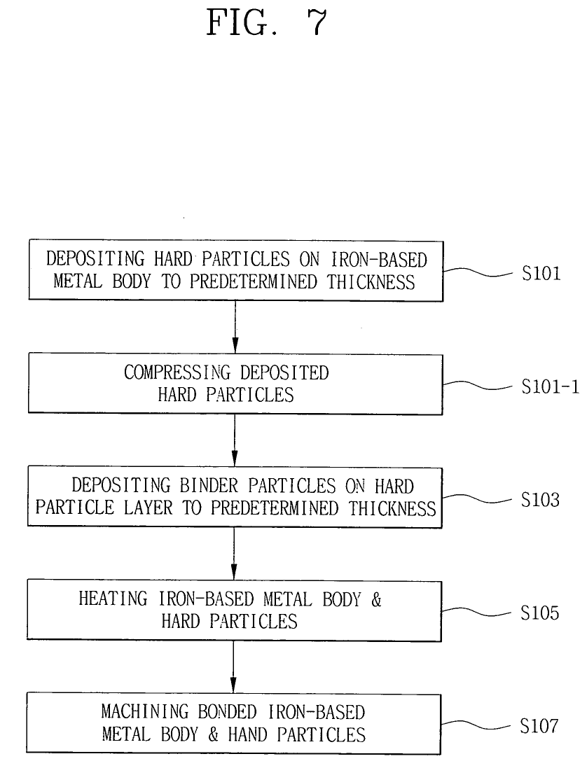

The wear-resistant mechanical component produced through various steps as described above has a iron-based metal body 10 and a super-hard alloy layer 10 bonded together with high bond strength as shown in FIG. 6.

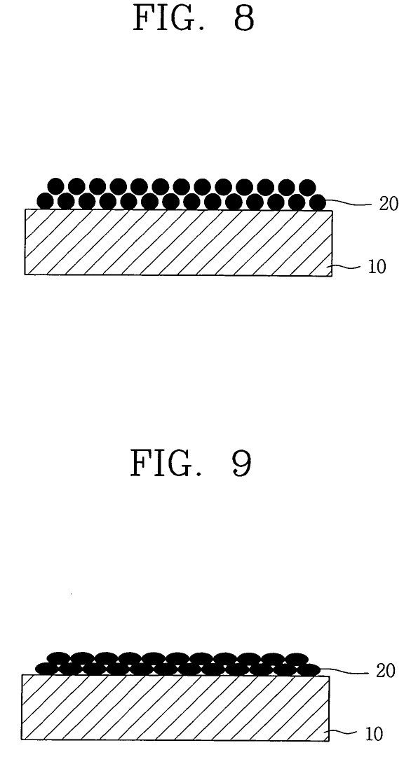

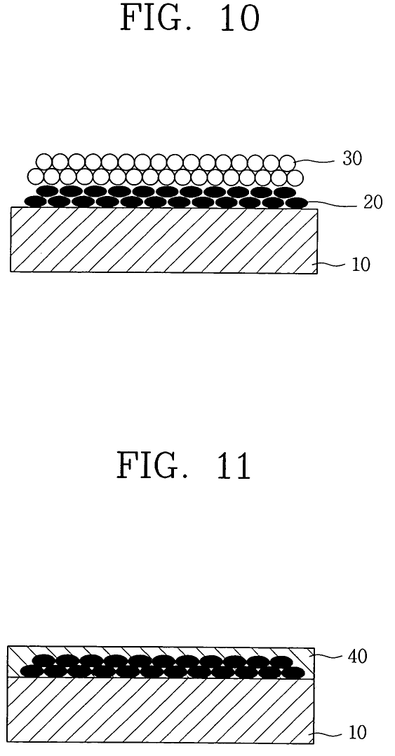

FIGS. 7 to 11 show another embodiment of the inventive method of producing a wear-resist mechanical component. The method in this embodiment further comprises the step of compressing the deposited hard particle layer 20 by using compression means such as a press (S101-1) after the hard particles are deposited in a predetermined thickness on the iron-based metal body 10 (S101).

The reasons for compressing the hard particle layer 20 is to evenly and uniformly distribute the hard particles on the iron-based metal body 10 as well as to reduce the voids formed between the hard particles. Uneven distribution of hard particles on the iron-based metal body 10 may reduce hardness of the super-hard alloy at the time of heat treatment to be followed. In addition, unless the voids formed between the hard particles are reduced, the expensive binder penetrating into the voids are excessively used, thereby causing increased manufacturing costs and deteriorated hardness of the super-hard alloy.

Meanwhile, the pressure applied in the process of compressing the deposited hard particle layer 20 is preferably in the range of about 10 to 5,000 kg/cm². The pressure of less than 10 kg/cm² is insufficient to evenly and uniformly distribute the hard particles and to remove the voids between the hard particles. In addition, the pressure of greater than 5,000 kg/cm² may cause deformation of the iron-based metal body 10. Therefore, it is preferred that the pressure of compressing the hard particle layer 20 is preferably in the range of about 10 to 5,000 kg/cm².

According to the method in this embodiment, by reducing the inter-particle voids and enhancing the density through the compression of the hard particle layer 20, excessive use of the expensive binder can be avoided and the hardness of the super-hard alloy can be increased at the time of heat treatment. In particular, increasing the hardness of the super-hard alloy can enhance the wear resistance of the wear-resistant mechanical component.

Various kinds of mechanical components were produced by using the inventive method while changing the composition ratio of the binder and heating condition within the ranges described above and performed abrasion tests for the produced wear-resistant mechanical components in the following examples.

### EXAMPLE 1

Hard particles in the amount of 100 g formed of tungsten carbide (WC) powders were evenly and uniformly distributed and positioned on a disc-shaped iron-based metal body with a diameter of 5 cm, and then compressed with a pressure of 100 kg/cm². Then, binder powders containing carbon (C) powders in the amount of 0.45 wt %, boron (B) powders in the amount of 3.5 wt %, silicon (Si) powders in the amount of 3.0 wt %, chromium (Cr) powders in the amount of 8.0 wt %, iron (Fe) powders in the amount of 2.5 wt % and balance nickel (Ni) powders were evenly positioned on the compressed hard particle layer in the amount of 80 g which is 0.8 times of the weight of the hard particles, then the iron-based metal body with the hard particle layer and the binder layer was loaded into a heating furnace of a vacuum atmosphere, heated to a temperature of 1,100° C. and then maintained for one hour at that temperature, thereby producing a wear-resistant mechanical component with a super-hard alloy layer having a thickness of about 1.5 mm. Neither unevenness nor crack was observed in the resultant super-hard alloy-bonded body and the hardness of the super-hard alloy layer was also evenly obtained in the range of about HRA 80 to 83. In addition, as a result of abrasion tests using earth and sand, it was confirmed that the wear amount of the super-hard alloy layer is not more than one third of that of an iron-based alloy.

### EXAMPLE 2

Hard particles in the amount of 100 g formed of silicon nitride (Si₃N₄) powders were evenly and uniformly distributed and positioned on a disc-shaped iron-based metal body with a diameter of 5 cm, and then compressed with a pressure of 1,000 kg/cm². Then, alloyed binder powders containing carbon (C) powders in the amount of 0.010 wt %, boron (B) powders in the amount of 0.5 wt %, silicon (Si) powders in the amount of 3.0 wt %, chromium (Cr) powders in the amount of 2.0 wt %, iron (Fe) powders in the amount of 0.1 wt % and balance nickel (Ni) powders were evenly positioned on the compressed hard particle layer in the amount of 50 g which is 0.5 times of the weight of the hard particles, then the iron-based metal body with the hard particle layer and the binder layer was loaded into a heating furnace of a vacuum atmosphere, heated to a temperature of 1,050° C. and then maintained for one hour at that temperature, thereby producing a wear-resistant mechanical component with a hard alloy layer having a thickness of about 0.8 mm. Neither unevenness nor crack was observed in the resultant hard alloy-bonded body and the hardness of the hard alloy layer was also evenly obtained in the range of about HRA 82 to 85. In addition, as a result of abrasion tests using earth and sand, it was confirmed that the wear amount of the hard alloy layer is not more than one fifth of that of an iron-based alloy.

### EXAMPLE 3

Hard particles in the amount of 100 g formed of tungsten carbide (WC) powders in the amount of 80 g and chromium carbide (Cr₃C₂) powders in the amount of 20 g were evenly and uniformly distributed and positioned on a disc-shaped iron-based metal body with a diameter of 5 cm, and then compressed with a pressure of 1,500 kg/cm². Then, alloyed binder powders containing carbon (C) powders in the amount of 1.0 wt %, boron (B) powders in the amount of 10.0 wt %, silicon (Si) powders in the amount of 12.0 wt %, chromium (Cr) powders in the amount of 20.0 wt %, iron (Fe) powders in the amount of 4.0 wt % and balance nickel (Ni) powders were evenly positioned on the compressed hard particle layer in the amount of 30 g which is 0.3 times of the weight of the hard particles, then the iron-based metal body with the hard particle layer and the binder layer was heated to a temperature of 1,200° C. using an oxygen torch and then maintained for five minutes at that temperature, thereby producing a wear-resistant mechanical component with a super-hard alloy layer having a thickness of about 0.8 mm. Neither unevenness nor crack was observed in the resultant super-hard alloy-bonded body and the hardness of the super-hard alloy was also evenly obtained in the range of about HRA 84 to 86. In addition, as a result of abrasion tests using earth and sand, it was confirmed that the wear amount of the super-hard alloy layer is not more than one sixth of that of an iron-based alloy.

### EXAMPLE 4

Hard particles in the amount of 100 g formed of tungsten carbide (WC) powders in the amount of 80 g and chromium carbide (Cr₃C₂) powders in the amount of 20 g were evenly and uniformly distributed and positioned on a disc-shaped iron-based metal body with a diameter of 5 cm, and then compressed with a pressure of 1,500 kg/cm². Then, binder powders containing boron carbide (B₄C) powders in the amount of 3.5 wt %, silicon (Si) powders in the amount of 4.5 wt %, chromium (Cr) powders in the amount of 11.0 wt %, iron (Fe) powders in the amount of 2.8 wt % and balance nickel (Ni) powders were evenly positioned on the compressed hard particle layer in the amount of 20 g which is 0.2 times of the weight of the hard particles, then the iron-based metal body with the hard particle layer and the binder layer was heated to a temperature of 1,100° C. using a heating furnace of reducing atmosphere and then maintained for thirty minutes at that temperature, thereby producing a wear-resistant mechanical component with a super-hard alloy layer having a thickness of about 0.3 mm. Neither unevenness nor crack was observed in the resultant super-hard alloy-bonded body and the hardness of the super-hard alloy layer was also evenly obtained in the range of about HRA 85 to 86. In addition, as a result of abrasion tests using earth and sand, it was confirmed that the wear amount of the super-hard alloy layer is not more than one seventh of that of an iron-based alloy.

### EXAMPLE 5

Hard particles in the amount of 100 g formed of tungsten carbide (WC) powders in the amount of 80 g and silicon nitride (Si₃N₄) powders in the amount of 20 g were evenly and uniformly distributed and positioned on a disc-shaped iron-based metal body with a diameter of 5 cm, and then compressed with a pressure of 10 kg/cm². Then, alloyed binder powders containing boron carbide (B₄C) powders in the amount of 2.5 wt %, silicon (Si) powders in the amount of 4.5 wt %, chromium (Cr) powders in the amount of 11.0 wt %, iron (Fe) powders in the amount of 2.8 wt % and balance nickel (Ni) powders were evenly positioned on the compressed hard particle layer in the amount of 80 g which is 0.8 times of the weight of the hard particles, then the iron-based metal body with the hard particle layer and the binder layer was heated to a temperature of 980° C. using a heating furnace of vacuum atmosphere and then maintained for five minutes at that temperature, thereby producing a wear-resistant mechanical component with a super-hard alloy layer having a thickness of about 1.5 mm. Neither unevenness nor crack was observed in the resultant super-hard alloy-bonded body and the hardness of the super-hard alloy layer was also obtained in the range of about HRA 80 to 82. In addition, as a result of abrasion tests using earth and sand, it was confirmed that the wear amount of the super-hard alloy is not more than one fourth of that of an iron-based alloy.

### EXAMPLE 6

Hard particles in the amount of 100 g formed of tungsten carbide (WC) powders in the amount of 80 g, silicon nitride (Si₃N₄) powders in the amount of 16 g and boron carbide (B₄C) powders in the amount of 4 g were evenly and uniformly distributed and positioned on a disc-shaped iron-based metal body with a diameter of 5 cm, and then compressed with a pressure of 5,000 kg/cm². Then, alloyed binder powders containing boron carbide (B₄C) powders in the amount of 2.0 wt %, silicon (Si) powders in the amount of 4.5 wt %, chromium (Cr) powders in the amount of 11.0 wt %, iron (Fe) powders in the amount of 2.8 wt % and balance nickel (Ni) powders were evenly positioned on the compressed hard particle layer in the amount of 90 g which is 0.9 times of the weight of the hard particles, then the iron-based metal body with the hard particle layer and the binder layer was heated to a temperature of 1,100° C. using a heating furnace of vacuum atmosphere and then maintained for five minutes at that temperature, thereby producing a wear-resistant mechanical component with a hard alloy layer having a thickness of about 2.0 mm. Neither unevenness nor crack was observed in the resultant hard alloy-bonded body and the hardness of the hard alloy layer was also evenly obtained in the range of about HRA 87 to 88. In addition, as a result of abrasion tests using earth and sand, it was confirmed that the wear amount of the hard alloy layer is not more than one tenth of that of an iron-based alloy.

### EXAMPLE 7

Hard particles in the amount of 100 g formed of tungsten carbide (WC) powders in the amount of 80 g, silicon nitride (Si₃N₄) powders in the amount of 16 g and boron carbide (B₄C) powders in the amount of 4 g were evenly and uniformly distributed and positioned on a disc-shaped iron-based metal body with a diameter of 5 cm, and then compressed with a pressure of 5,000 kg/cm². Then, alloyed binder powders containing boron carbide (B₄C) powders in the amount of 2.0 wt %, silicon (Si) powders in the amount of 4.5 wt %, chromium (Cr) powders in the amount of 11.0 wt %, iron (Fe) powders in the amount of 2.8 wt % and balance nickel (Ni) powders were evenly positioned on the compressed hard particle layer in the amount of 400 g which is 4 times of the weight of the hard particles, then the iron-based metal body with the hard particle layer and the binder layer was heated to a temperature of 1,100° C. using a heating furnace of vacuum atmosphere and then maintained for five minutes at that temperature, thereby producing a wear-resistant mechanical component with a hard alloy layer having a thickness of about 5.0 mm. Neither unevenness nor crack was observed in the resultant hard alloy-bonded body and the hardness of the hard alloy layer was also evenly obtained in the range of about HRA 87 to 88. In addition, as a result of abrasion tests using earth and sand, it was confirmed that the wear amount of the hard alloy is not more than one third of that of an iron-based alloy.

As a result, it was found that wear-resistant components produced with the above mentioned compositional ratios and heating conditions using the inventive method is excellent in wear resistance and impact resistance.

As described above, according to the present invention, it is possible to obtain a wear-resistant mechanical component having high hardness and excellent wear resistance. In particular, it is possible to obtain a wear-resistant mechanical component without the steps of mixing hard particles with binder and shaping the mixture as in the prior art. Furthermore, because mixing and shaping steps are not performed, the entire working process can be shortened and working hours and costs can be greatly reduced. Moreover, because the hard particles and binder are heated and bonded together after being deposited on a base metal body, it is possible to bond super-hard alloy to a base metal body regardless of the shape of the base metal body.

While the invention has been shown and described with reference to certain preferred embodiments thereof, it will be understood by those skilled in the art that various changes in form and details can be made therein without departing from the spirit and scope of the invention as defined by the appended claims.

1. A method of producing a wear-resistant mechanical component comprising the steps of:
depositing hard particles of one or more substances selected from the group consisting of carbides, nitrides and borides on an iron-based metal body to a predetermined thickness;
depositing powders of binder atop of the hard particle layer to a predetermined thickness; and
heating the hard particles, the binder powders and the iron-based metal body, so that the iron-base metal body and the hard particles are bonded together.

2. A method as recited in claim 1, further comprising the step of compressing the deposited hard particle layer with a predetermined pressure, after the step of depositing the hard particles on the iron-based metal body.

3. A method as recited in claim 2, wherein the predetermined pressure at the step of compressing the hard particles is in the range of 10 to 5,000 kg/cm².

4. A method as recited in claim 1, wherein the binder powders contain boron (B) in the amount of 1 to 5 wt %, silicon (Si) in the amount of 1 to 5 wt %, chromium (Cr) in the amount of 5 to 10 wt %, iron (Fe) in the amount of 1 to 5 wt %, on the basis of the total weight of the entire composition of the binder, and balance nickel.

5. A method as recited in claim 4, wherein the binder is added in the amount of 1 to 5 times greater than the hard particles by weight.

6. A method as recited in claim 1, wherein the step of heating is performed for 5 minutes to 10 hours at a temperature of 980° C. to 1,200° C.

7. A method as recited in claim 1, wherein the binder powders contain carbon (C) in the amount of 0.01 to 1 wt %, boron (B) in the amount of 0.5 to 10 wt %, silicon (Si) in the amount of 3 to 12 wt %, chromium (Cr) in the amount of 2 to 20 wt %, iron (Fe) in the amount of 0.1 to 4 wt %, on the basis of the weight of the entire composition of the binder, and balance nickel.

8. A method as recited in claim 7, wherein the binder powders are added in the amount of 0.2 to 4 times greater than the hard particles by weight.

9. method as recited in claim 1, wherein the binder powders contain boron carbide (B₄C) in the amount of 0.6 to 11 wt %, silicon (Si) in the amount of 3 to 12 wt %, chromium (Cr) in the amount of 2 to 20 wt %, iron (Fe) in the amount of 0.1 to 4 wt %, on the basis of the weight of the entire composition of the binder, and balance nickel.

10. A method as recited in claim 4, wherein the binder powders are prepared by mixing the respective element of the powders.

11. A method as recited in claim 4, wherein the binder powders comprises powders of alloy of the respective binder element.

12. A wear-resistant mechanical component produced by the method as recited in claim 1.
